(19) United States
(12) Patent Application Publication
(10) Pub. No.: US 2007/0089917 A1
(43) Pub. Date: Apr. 26, 2007

(54) Wheelbarrow

(76) Inventor: Brian Hartley, Chesterfield (GB)

Correspondence Address: SMITH-HILL AND BEDELL, P.C., 16100 NW CORNELL ROAD, SUITE 220, BEAVERTON, OR, 97006, US

(21) Appl. No.: 10/561,136

(22) PCT Filed: Jun. 14, 2004
(86) PCT No.: PCT/GB04/02565

§ 371 Date: Jan. 10, 2006

(30) Foreign Application Priority Data
Jun. 17, 2003 (GB) 0313996.1
Sep. 27, 2003 (GB) 0322666.9
Mar. 17, 2004 (GB) 0405915.0

(51) Int. Cl. B60K 1/00

(52) U.S. Cl. 180/65.1

(57) ABSTRACT

A wheelbarrow incorporates an electric motor and mechanical drive coupling such that motorized assistance is provided to the wheelbarrow when required. Typically a sustained switch is provided such that drive to a wheel only occurs when required.

The present invention relates to wheelbarrows and more particularly power assisted wheelbarrows.

Conventional wheelbarrows are well known. Wheelbarrows are used to transport materials, such as garden waste or building sand, from one place to another.

Generally, a wheelbarrow has one wheel at the front and two handles at the rear with a stand to hold the barrow level when not lifted.

The wheel at the front can jam when heavy objects are being transported over rough ground. Furthermore, wheelbarrows can be hard to push up hill or when negotiating steps, etc. Thus, in the past it has been known to provide wheelbarrows with a combustion engine to provide traction.

Although power assistance through combustion engines has been applied to wheelbarrows, it will be appreciated that combustion engines themselves add significantly to wheelbarrow weight, and generally a combustion engine is in continuous operation in order to provide traction. It will be understood a starter motor and other elements for instantaneous operation will not be provided. Furthermore, it will also be understood that combustion engines are generally noisy and therefore may not be acceptable in gardening situations. In such circumstances it may be considered that use of a combustion engine is relatively excessive upon a wheelbarrow when the necessity for traction assistance may only be required sporadically.

The present invention seeks to overcome these problems by allowing the operator of a wheelbarrow to negotiate objects that the wheelbarrow may encounter, and manoeuvre it more easily by selectively engaging powered assistance when required.

In accordance with the present invention there is provided a wheelbarrow comprising an electric motor with a mechanical coupling to a wheel, the electric motor controlled to selectively drive the wheel when required and allow that wheel to freely rotate when not driven by the electric motor.

Advantageously, the electric motor is controlled by a switch, which may be of a hold to sustain operation type, to allow an operator to determine whether the wheel is driven or not. Additionally or alternatively, the electric motor is controlled by a status sensor. Possibly the status sensor senses wheelbarrow speed and/or barrow load and/or travel angle in order to determine whether the wheel is driven.

Advantageously, the electric motor is detachable.

Typically, the electric motor is detachable.

Typically, the mechanical coupling is a chain or belt between the wheel and the electric motor.

Generally, the wheel has a sprocket cog for mechanical coupling from the electric motor. Normally, the sprocket cog is sized relative to a drive cog coupled to the electric motor such that there is appropriate mechanical advantage to enable the wheel to be driven. Possibly, the relative gear ratios between the sprocket cog and the drive cog may be altered by a user.

Generally, the electric motor is coupled to a detachable electrical battery. Normally the electrical battery is rechargeable. Possibly, the electric motor and/or the electrical battery are held in waterproof mountings.

Advantageously, a mounting for the electric motor is able to receive motors of differing power as required by expected operational requirements.

Also, in accordance with the present invention there is provided a drive mechanism for retro fit to a wheelbarrow, the mechanism comprising an electric motor, a battery and mechanical coupling for coupling the electric motor to a wheel, the electric motor controlled by a control switch to allow selective driving of the wheel when required and allow relative free rotation of the wheel when not.

Normally, the mechanism will incorporate a sprocket cog to be secured to a hub of a wheel to which the mechanical coupling is provided for coupling the motor to the wheel.

An electric motor is fitted in a suitable position to allow a drive train to be connected to the wheel of the wheelbarrow. The drive train can consist of two sprockets, one with a small sprocket and a ratchet system fitted to the centre (similar to a bicycle free rear wheel). This is fitted to the shaft of a gearbox, which is driven by an electric motor. A larger sprocket is fixed to the shaft attached to the wheel on a wheelbarrow, or directly onto the side of the wheel. A chain is fitted between the two sprockets to enable the electric motor to drive the wheel on the wheelbarrow.

A rechargeable battery is fitted on the underside of the wheelbarrow and this can be of a plug in type so that as one battery is exhausted a second battery, which has been charged, can be plugged into a socket which connects it to suitable electrical switchgear. The battery can then be connected to a bell type press switch which is fitted adjacent to one of the handles of the wheelbarrow. When the bell switch is pressed contact is made through wiring to the electric motor. As a second connection is also made from the battery to the electric motor, this causes the wheel on the wheelbarrow to turn. The operator must raise the rear of the wheelbarrow using the two handles at the same time as the bell push is pressed, the wheelbarrow will then move forward. If the operator does not require assistance from the electric motor he simply takes his finger off the bell push.

The wheelbarrow can still be pushed forward by the use of the operator's own power, this is because the free wheel sprocket fitted to the end of the gearbox allows it to turn without the electric motor or gearbox turning at the same time.

A toothed belt and suitable pulleys could also be used instead of being chain driven if required.

The wiring to the various connections on the wheelbarrow can, where practicable, run inside the frame of the wheelbarrow.

Embodiments of the present invention will now be described by way of example only, with reference to the accompanying drawings, in which:

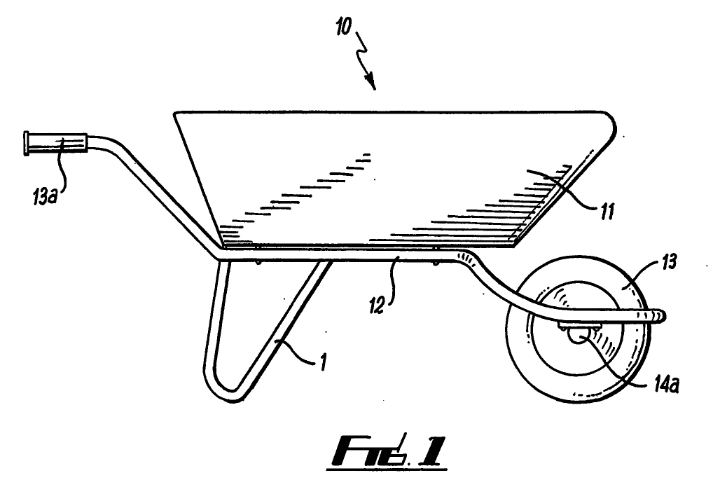

FIG. 1 depicts a side view of a typical wheelbarrow;

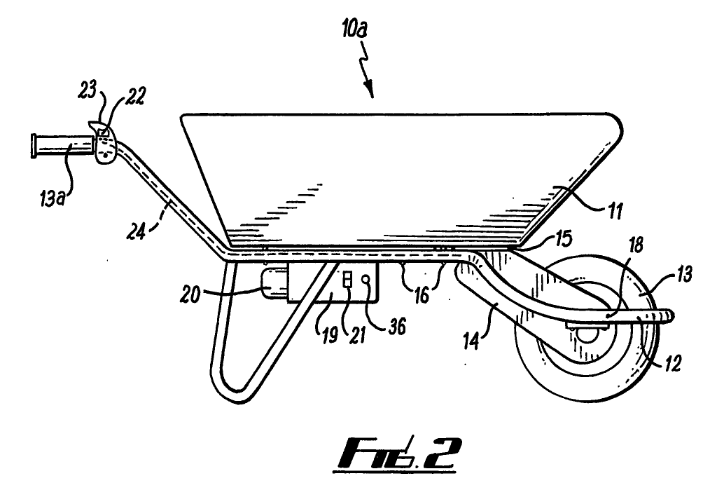

FIG. 2 depicts the wheelbarrow shown in FIG. 1 with a drive mechanism in accordance with the present invention;

FIG. 3 depicts a side view of a drive train casing;

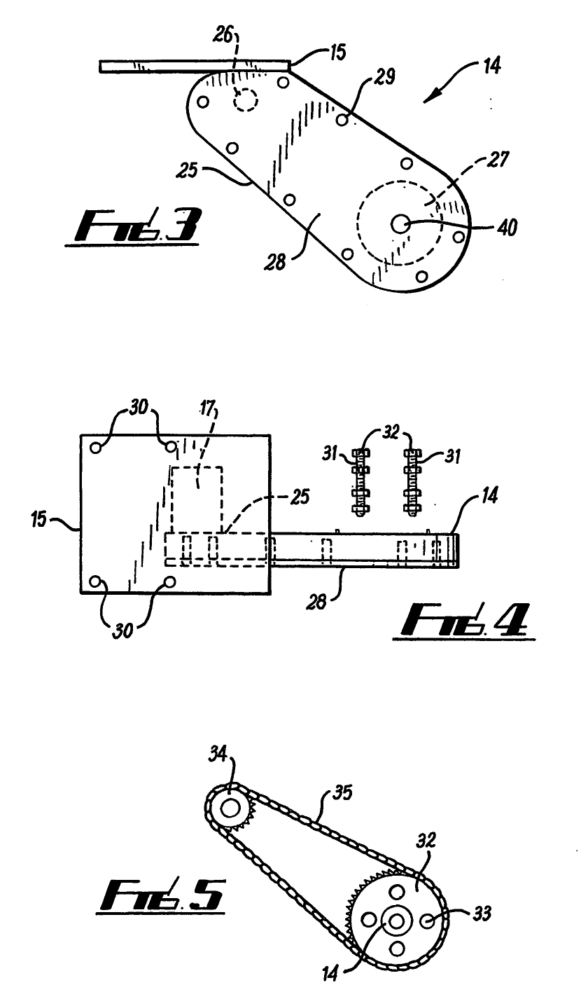

FIG. 4 depicts a view from above of the drive train casing shown in FIG. 3; and,

FIG. 5 depicts a drive sprocket and wheel sprocket mechanically coupled by a drive chain.

Referring to FIG. 1 depicting a conventional wheelbarrow 10, with a barrow or container 11, a support frame 12, and a wheel 13. There are a pair of handles 13a, (only one side is shown), and two bearings 14a, (only one side is shown) to support the wheel 13. A stand part 1 of the frame holds the container 11 in a level aspect when at rest. The barrow 10 is lifted by handles 13a to allow it to be pushed forwards or pulled rearwardly. Thus, all of the weight of wheelbarrow and any load in the container is placed on the wheel 13 when the wheelbarrow is lifted.

As indicated above, wheelbarrows have been known and used for a significant period of time. Furthermore, the wheel 13 as indicated can become embedded in soft surfaces, and being of a relatively small nature does not greatly assist when attempting to push the wheelbarrow 10 uphill or up a flight of steps. Nevertheless, most wheelbarrow operations will be on relatively flat surfaces where most operators will be able to lift and push the wheelbarrow without physically overstretching themselves.

The present invention relates to providing modifications to a wheelbarrow 10 such that where necessary sporadic power assistance can be provided to the wheelbarrow without greatly increasing the normal operational weight of the wheelbarrow or impinging upon its normal function.

FIG. 2 depicts a modified wheelbarrow 10a, which has been modified to make it power assisted or driven. A casing 14 is arranged between the frame 12 and the container 11. A flat plate 15 is sandwiched between the frame 12 and container 11 with four bolts 16, used to secure the plate 15. The casing 14 covers the two sprockets 32 and 34 and drive chain 35, whose operation is described later. An electric motor 17 is bolted to the plate 15. A lower section of the casing 14, is bolted 18, to the frame 12, of the wheelbarrow 10a. A battery box 19, is fixed below the container 11, and a battery 20 is plugged into the box 19. The battery 20 is normally detachable or easily replaceable. Advantageously, the battery 20 will be held in a waterproof box or mounting.

Normally a fuse is fitted to protect a control electrical circuit 36, and an isolation switch 21 provided to inhibit leakage discharge of the battery 20. A hold to sustain door bell type switch 22, is fitted to one of the handles 13a. This switch 22 has a cover 23, to protect the switch 22, from any water or dirt ingress that may affect the operation of the switch. Wiring 24, is threaded through a hole (not shown) in the support frame 12 of the wheelbarrow 10, and this is connected between the switch 22, the battery in the box 19, and the electric motor 17. The box 19 may be open as shown to allow easy access to the battery or closable in order to provide protection for the battery from dirt and water as well as provide necessary safeguards for electrical regulations, etc.

In view of the above, it will be appreciated that the modified wheelbarrow 10a incorporates a relatively lightweight drive mechanism comprising the electric motor (not shown), a battery 20 secured within a box 19 and a mechanical coupling mechanism between the electric motor and the wheel 13 encased within a casing 14. Electrical wiring 24 is provided to enable a switch 22 to activate the electric motor and then through a drive shaft to a gearbox within the mechanical coupling to the wheel 13 drive a chain or belt to the wheel 13 in order to turn that wheel 13 as required.

As indicated above, normally the switch 22 is a hold and sustain type switch such that an operator must maintain pressure on the switch 22 for continued operation of the drive mechanism. When the drive mechanism is not engaged it will be understood that an electric motor of the size utilised in accordance with the present invention will provide little or no drag through the mechanical coupling upon wheel 30 rotation such that it is relatively free to rotate and operate in a normal fashion as if the mechanism was not incorporated in the wheelbarrow 10a.

Effectively the present drive mechanism is supported on the plate 15 which is secured to the bottom of the container 11 appropriately through screws 16 such that the box 19 and battery 20 are supported whilst the casing 14 will generally be located within the frame 12 which generally comprises a U bend to support the bearings for the hub of the wheel 13.

As will be described later, the wheel 13 and in particular its hub is generally drilled to accommodate a wheel drive sprocket cog 32 so location of the casing within this U bend fork of the frame 12 will be achieved at this stage.

It will be understood that wheelbarrows can be designated for different expected work functions. Thus, wheelbarrows for general domestic garden operations will generally be subject to relatively low loads, whilst heavier duty wheelbarrows will be used in building and demolition trades. In such circumstances in accordance with the present invention the casing 14 and plate 15 may be designated to accommodate different power rating electric motors dependent upon expected use. It will be understood that generally speaking higher power or torque electric motors will be heavier, but such heavier motors will still only represent a relatively small proportion of the expected loads to be placed within the container 11. In any event, electric motors in accordance with the present invention would generally be readily detachable from the wheelbarrow 10a when not required or for servicing. Similarly, the battery 20 will be readily detachable for recharging or replacement when electrical charge is depleted.

Preferably, in accordance with the present invention the switch 22 will be manually operated such that power assistance through the electric motor and drive mechanism will only be provided when required by an operator. However, through appropriate control circuitry it may be possible to monitor wheelbarrow operation in terms of speed, load placed within the container 11 or angle of travel such that electrical power of varying levels may be provided in order to assist the operator automatically when required. Such automatic operation may be switched into action by a permanent switch associated with the wheelbarrow 10a.

In FIG. 3a side view of the casing 14 is depicted. This casing 14 supports and covers the drive train shown in and described later with regard to FIG. 5. A flat plate 15, is welded or bolted to the casing 14. The casing 14 has a hole 26, for a drive shaft of a gearbox (not shown) which is connected to the electric motor 17, (see FIG. 4). A larger hole 27 is for the drive shaft to pass through for the wheel 13 (FIG. 1). A cover plate 28, is held in place by nine screws 29.

The casing 14 provides a unitary element of the drive mechanism which can be readily secured to a wheelbarrow in use. The casing 14 incorporates as indicated a hole 26 for a drive shaft from an electric motor normally via a gearbox at one end and an aperture 27 at the other within which mountings for assembly of the drive mechanism to a wheel hub can be secured. Generally, within the aperture 27 on one side of the casing 14 there is a hole 40 on the other through which the wheel hub shaft 2 and wheel bearings pass in use.

FIG. 4 depicts in a plan view the box section 14 which extends from the cover plate 28. Four bolt holes 30, at each corner of the plate 15 hold it in place and screws 16, (FIG. 2), to pass through the plate 15 to secure it to the frame 12. The electric motor 17, is secured to a box portion 25 which extends from the section 14, below the plate 15. Four threaded rods 31, (only 2 shown) pass through holes in a wheel sprocket secured to the wheel 13. The holes at an opposite end of the casing 14 to the electric motor 17. These rods 31 are used to secure the large wheel drive cog 32, using the four holes 33 in the sprocket for this purpose using two nuts at one end of the threaded rods 31. Four holes are drilled in the barrow wheel (not shown) for the other ends of the four threaded rods 31, to fit through and these are secured by the two nuts at the end of each threaded rod 31. A grub screw can be used as an alternative to fix the sprocket to the wheel shaft if the shaft is permanently fixed to the wheel.

As indicated above, the electric motor 17 is secured below the plate 15 which will protect it from percussive impact when loading the container 11, but nevertheless the motor 17 will be generally provided within a protective housing to provide some protection from ingress of earth and other debris from below. The motor 17 as indicated provides a drive shaft to a gearbox normally at the portion 25 in order that a cog is rotated appropriately for mechanical advantage in turning the barrow wheel. However. where possible with low speed electric motors or stepping electric motors, the motor may be directly coupled to the drive cog of the drive mechanism.

Generally, the drive cog associated with the electric motor will be coupled to the wheel drive cog through a chain or toothed drive belt. In such circumstances the cog itself will incorporate gear teeth or other means to register that belt with the driving cog, etc.

The drive mechanism in accordance with the present invention should be relatively lightweight and easily installed and/or detached. In such circumstances a simple cog to cog belt or chain coupling will be advantageous. However, as indicated above, it will be appreciated that wheelbarrow operation may vary from relatively light domestic gardening duties to more heavyweight building duties such that by use of differing sized drive cogs associated with the electric motor and driven cog associated with the wheel, different degrees of mechanical advantage may be provided in order that the wheel is driven appropriately dependent upon the expected loadings placed upon that wheel.

In such circumstances, one or both of the cogs may be readily changed by a user as required.

FIG. 5 shows the drive mechanism from the electric motor 17 depicted in FIG. 4, to the wheelbarrow wheel 13, FIG. 1. The mechanism consists of a sprocket cog 34, which is fitted onto the drive shaft of the gearbox fitted to the electric motor, and a larger sprocket cog 32, which is secured to the wheel 13, of the wheelbarrow. A chain 35, is used to make the drive connection between the cogs 32, 34. When the electrical circuit is made, FIG. 2, by the operator lifting the wheelbarrow using the handles 13, FIG. 1, and pressing the switch 22, the electric motor 17, drives the chain 35 to turn the cogs 32, 34 and so move the wheelbarrow forward. This will occur whilst the battery is charged.

As indicated previously, cogs 32 and 34 provide a final determination of mechanical advantage in terms of their relative size and ratio between the driving of the electric motor and the rotational speed of the wheel associated with the wheel cog 32. In such circumstances, dependent upon expected use of the wheelbarrow incorporating the drive mechanism, the sizes of the cogs 32, 34 will be determined.

Whilst endeavouring in the foregoing specification to draw attention to those features of the invention believed to be of particular importance, it should be understood that the Applicant claims protection in respect of any patentable feature or combination of features hereinbefore referred to and/or shown in the drawings whether or not particular emphasis has been placed thereon.

1-27. (canceled)

28. A wheelbarrow comprising an electric motor with a mechanical coupling to a wheel, the electric motor controlled to selectively drive the wheel when required and allow that wheel to freely rotate when not driven by the electric motor.

29. A wheelbarrow as claimed in claim 28 wherein the electric motor is controlled by a switch.

30. A wheelbarrow as claimed in claim 29 wherein the switch is of a hold to sustain operation type, to allow an operator to determine whether the wheel is driven or not.

31. A wheelbarrow as claimed in claim 28 wherein the electric motor is controlled by a status sensor.

32. A wheelbarrow as claimed in claim 31 wherein the status sensor senses wheelbarrow speed and/or barrow load and/or travel angle in order to determine whether the wheel is driven.

33. A wheelbarrow as claimed in claim 28 wherein the electric motor is detachable.

34. A wheelbarrow as claimed in claim 28 wherein the mechanical coupling is a chain or belt between the wheel and the electric motor.

35. A wheelbarrow as claimed in claim 28 wherein the wheel has a sprocket cog for mechanical coupling from the electric motor.

36. A wheelbarrow as claimed in claim 35 wherein the sprocket cog is sized relative to a drive cog coupled to the electric motor such that there is appropriate mechanical advantage to enable the wheel to be driven.

37. A wheelbarrow as claimed in claim 36 wherein the mechanical advantage between the sprocket cog and the drive cog may be altered by a user.

38. A wheelbarrow as claimed in claim 37 wherein the electric motor is coupled to a detachable electrical battery.

39. A wheelbarrow as claimed in claim 38 wherein the electrical battery is rechargeable.

40. A wheelbarrow as claimed in claim 28 wherein the electric motor and/or any electrical battery are held in waterproof mountings.

41. A wheelbarrow as claimed in claim 28 wherein a mounting for the electric motor is able to receive motors of differing power as required by expected operational requirements.

42. A drive mechanism for retro fit to a wheelbarrow, the mechanism comprising an electric motor, a battery and mechanical coupling for coupling the electric motor to a wheel, the electric motor controlled by a control switch to allow selective driving of the wheel when required and allow relative free rotation of the wheel when not.

43. A mechanism as claimed in claim 42 wherein the mechanism will incorporate a sprocket cog to be secured to a hub of a wheel to which the mechanical coupling is provided for coupling the motor to the wheel.

44. A mechanism as claimed in claim 42 wherein an electric motor is fitted in a suitable position to allow a drive train to be connected to the wheel of the wheelbarrow.

45. A mechanism as claimed in claim 44 wherein the drive train can consist of two sprockets, one with a small sprocket and a ratchet system fitted to the centre (similar to a bicycle free rear wheel).

46. A mechanism as claimed in claim 44 wherein the drive train is fitted to a shaft of a gearbox which is driven by an electric motor.

47. A mechanism as claimed in claim 42 wherein a larger sprocket is fixed to the shaft attached to the wheel on a wheelbarrow, or directly onto the side of the wheel.

48. A mechanism as claimed in claim 45 wherein a chain is fitted between the two sprockets to enable the electric motor to drive the wheel on the wheelbarrow.

49. A mechanism as claimed in claim 42 wherein a rechargeable battery is fitted on the underside of the wheelbarrow and this can be of a plug in type so that as one battery is exhausted a second battery, which has been charged, can be plugged into a socket which connects it to suitable electrical switchgear.

50. A mechanism as claimed in claim 49 wherein the battery can then be connected to a bell type press switch which is fitted adjacent to one of the handles of the wheelbarrow.

51. A mechanism as claimed in claim 50 wherein when the bell switch is pressed contact is made through wiring to the electric motor.
